(19) United States
(12) Patent Application Publication
(10) Pub. No.: US 2006/0112812 A1
(43) Pub. Date: Jun. 1, 2006

(54) Method and apparatus for adapting original musical tracks for karaoke use

(76) Inventors: Anand Venkataraman, Palo Alto, CA (US); Victor Abrash, Montara, CA (US); Harry Bratt, Mountain View, CA (US); Venkata Ramana Rao Gadde, Santa Clara, CA (US)

Correspondence Address: MOSER, PATTERSON & SHERIDAN, LLP;SRI INTERNATIONAL, 595 SHREWSBURY AVENUE, SUITE 100, SHREWSBURY, NJ, 07702, US

(21) Appl. No.: 11/000,271

(22) Filed: Nov. 30, 2004

(51) Int. Cl. G10H 7/00

(52) U.S. Cl. 84/616

(57) ABSTRACT

In one embodiment, the present invention is a method and apparatus for adapting original musical tracks for karaoke use. In one embodiment, an original musical track is separated into vocal elements and non-vocal elements. The vocal elements are aligned with corresponding text transcriptions (e.g., text-based lyrics), and the aligned text-based lyrics are then displayed to a user while the non-vocal elements are simultaneously played in a manner that is synchronous with the display of the lyrics.

### FIELD OF THE INVENTION

The present invention relates generally to entertainment systems, and relates more particularly to karaoke systems.

### BACKGROUND OF THE INVENTION

Karaoke systems have become increasingly popular means of entertainment at parties and other social events. However, cost-constraints limit the quality and capabilities of conventional private-use karaoke systems. For example, it is very difficult for conventional private-use karaoke systems to obtain original musical tracks for user performances (e.g., as opposed to musical tracks that are re-recorded by a karaoke system manufacturer and performed by anonymous artists in the same key as the original musical track). This limits the selection of music available to karaoke users. Furthermore, the selections that are available are often modified versions of the original works.

Moreover, many karaoke users would benefit from a system that provides a score or assessment of the user's performance, e.g., in comparison to the originally recorded track. However, presently available karaoke systems do not include this capability.

Thus, there is a need in the art for a method and apparatus for adapting original musical tracks for karaoke use.

### SUMMARY OF THE INVENTION

In one embodiment, the present invention is a method and apparatus for adapting original musical tracks for karaoke use. In one embodiment, an original musical track is separated into vocal elements and non-vocal elements. The vocal elements are aligned with corresponding text transcriptions (e.g., text-based lyrics), and the aligned text-based lyrics are then displayed to a user while the non-vocal elements are simultaneously played in a manner that is synchronous with the display of the lyrics.

### BRIEF DESCRIPTION OF THE DRAWINGS

The teaching of the present invention can be readily understood by considering the following detailed description in conjunction with the accompanying drawings, in which:

FIG. 1 is a flow diagram illustrating one embodiment of a method for adapting an original musical track for karaoke use;

FIG. 2 is a flow diagram illustrating one embodiment of a method for flexibly aligning the separated vocal elements to corresponding text-based lyrics; and

FIG. 3 is a high-level block diagram of the karaoke adaptation method that is implemented using a general purpose computing device.

To facilitate understanding, identical reference numerals have been used, where possible, to designate identical elements that are common to the figures.

### DETAILED DESCRIPTION

The present invention relates to karaoke systems, including karaoke systems that may be implemented for private or home use (e.g., at private parties or other social gatherings). The method and apparatus of the present invention may be implemented to transform virtually any computing device (including a desktop computer, a laptop computer, a cellular telephone, a personal digital assistant (PDA), a wristwatch, a portable music player, a car stereo, a hi-fi/entertainment center, a television, a gaming console, a dedicated karaoke device, a digital video recorder (DVR), or a cable or satellite set stop box, among others) into a karaoke system capable of adapting original musical tracks for karaoke use. Moreover, the method and apparatus of the present invention may be implemented to “score” a user's performance based on a comparison to the original musical track.

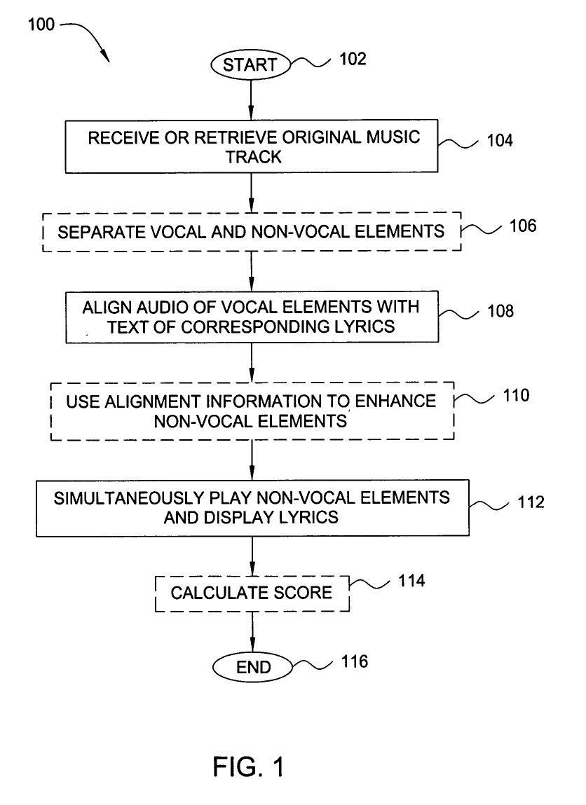

FIG. 1 is a flow diagram illustrating one embodiment of a method 100 for adapting an original musical track for karaoke use. As used herein, the term “original musical track” means a musical track that has not already been modified (e.g., re-recorded) for karaoke purposes. The method 100 is initiated at step 102 and proceeds to step 104, where the method 100 receives or retrieves an original musical track (e.g., from a compact disc, a digital music file, a video recording, or other source). In one embodiment, the method 100 retrieves the original musical track locally (e.g., from the user's computer); in another embodiment, the method 100 retrieves the musical track remotely (e.g., from a server or other remote computing device). In one embodiment, the original musical track comprises both vocal (e.g. voicing such as lyrics and other vocal utterances) and non-vocal (e.g., music) elements.

In optional step 106 (illustrated in phantom), the method 100 separates the original musical track into two portions: a first portion containing the original musical track's vocal elements and a second portion containing the original musical track's non-vocal elements. In one embodiment, step 106 is performed using any one or more known techniques for extracting vocals from stereo music files.

In step 108, the method 100 aligns the vocal elements of the original musical track with one or more text versions of the corresponding lyrics. In one embodiment, the text-based lyrics are input by the user. In another embodiment, the text-based lyrics are retrieved locally or remotely (e.g., from a local file or from the Internet). In one embodiment, this alignment step 108 is performed using the intact original musical track. In another embodiment, this alignment step 108 is performed using only vocal elements that have been separated from non-vocal elements of the original musical track (e.g., in accordance with optional step 106).

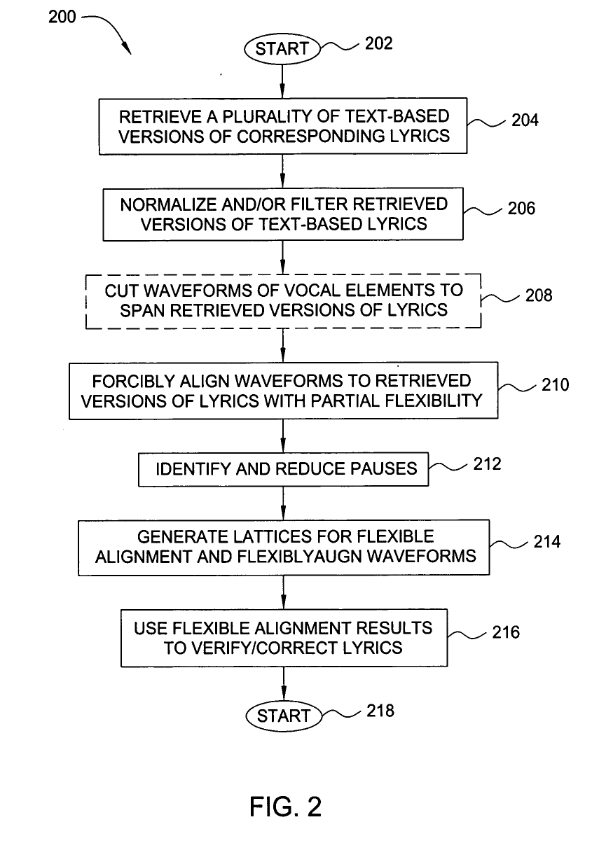

FIG. 2 is a flow diagram illustrating one embodiment of a method 200 for flexibly aligning the vocal elements to corresponding text-based lyrics. In one embodiment, multiple text-based versions of the corresponding lyrics may be available, and one or more of these multiple versions may contain errors in the transcription. The method 200 may be implemented in conjunction with a known speech recognition method to improve the accuracy of the alignment step 108, thereby improving the accuracy of the lyrics that are eventually displayed to a user/performer.

The method 200 is initialized at step 202 and proceeds to step 204, where the method 200 retrieves a plurality of text-based versions of the lyrics that correspond to the vocal elements of the original musical track. These text-based versions of the lyrics may be retrieved, for example, from multiple Internet web sites. In one embodiment, step 202 involves the selection of a predefined number of text-based versions of the lyrics from a given set of text-based versions.

In step 206, the method 200 normalizes and/or filters the retrieved versions of the text-based lyrics in order to canonicalize spellings and automatically correct obvious transcription errors. The method 200 then proceeds to optional step 208 (illustrated in phantom) and cuts waveforms of the vocal elements to approximately span the retrieved versions of the lyrics.

In step 210, the method 200 forcibly aligns the waveforms of the vocal elements to the normalized and filtered text-based lyrics. In one embodiment, this forcible alignment is performed with partial flexibility. That is, portions of the waveforms and portions of the text-based lyrics may be skipped in order to avoid failure of the alignment process.

In step 212, pauses in the aligned output of step 210 are identified and reduced. In one embodiment, pauses are reduced by iteratively cutting the waveforms at increasingly shorter pauses until substantially all of the waveforms are of manageable lengths (e.g., approximately thirty seconds or less).

In step 214, the method 200 generates lattices for flexible alignment and then flexibly aligns all of the waveforms using the generated flexible alignment lattices. In one embodiment, flexible alignment lattices are generated for each version of the text-based lyrics that is used in the method 200. In one embodiment, a flexible alignment lattice for a version of the text-based lyrics is generated by processing the version of the text-based lyrics to generate a hypothesis search graph having the following properties: (1) every word is optional; (2) every word is preceded by either an optional “garbage word” or a disfluency (e.g., “um”, “uh”, “hmm”, etc.); and (3) every word is followed by an optional pause of variable length. In one embodiment, the pause is modeled using a pause phone that is trained on background noise.

By making every word in the hypothesis search graph optional, arbitrary amounts of the text-based lyrics can be skipped while still entertaining the possibility of resynchronizing with the waveforms at a later point. By preceding every word in the hypothesis search graph with either a “garbage” word or a disfluency, some of the words that might be omitted by the transcription of the lyrics may be able to be recovered, and out-of vocabulary words (e.g., words not recognized by an implemented speech recognition system) may be aligned. By following every word in the hypothesis search graph with an optional pause, background noise may be more easily identified and distinguished from the speech to be recognized.

The method 200 then proceeds to step 216 and uses the flexible alignment results from step 214 to verify and/or correct the text-based versions of the lyrics. The method 200 terminates in step 218.

Referring back to FIG. 1, in one embodiment, once the method 100 aligns the vocal elements of the original musical track with a set of text-based lyrics, the method 100 proceeds optional step 110 (illustrated in phantom) and uses information gained during the alignment step 108 (e.g., regarding the presence or absence of voicing) to enhance the non-vocal elements of the original musical track. In one embodiment, this optional enhancement step 110 is applied when the vocal and non-vocal elements of the original musical track have been separated for alignment purposes (e.g., in accordance with step 106). That is, the method 100 may determine during alignment in step 106 that certain portions of the original musical track that were initially identified as vocal elements during the separation step 106 (for example, a harmonica track) are, in fact, non-vocal elements (e.g., because the elements do not correspond to the retrieved lyrics). The method 100 may, in step 110, add these elements back into the portion of the original musical track containing the non-vocal elements.

In step 112, the method 100 plays the portion of the original musical track containing the non-vocal (e.g., music) elements while simultaneously displaying the corresponding lyrics for the vocal elements (e.g., in text form) in a substantially synchronous manner. In one embodiment, display of the lyrics includes displaying synchronized lyric/word emphasis using the alignment information obtained in step 108. For example, the display may include an indicator that tells a user precisely when and/or for how long the displayed words and/or syllables should be sung or for how long certain notes should be held (e.g., such as a “follow the bouncing ball” indicator).

In one embodiment, the method 100 proceeds to optional step 114 (illustrated in phantom), where the method 100 calculates and displays a score assessing the user's performance (e.g., singing along to the original musical track elements played and displayed in step 112). In one embodiment, calculation of a user's performance score includes comparing one or more parameters of the user's performance to corresponding parameters of the original musical track. In one embodiment, these parameters include timing (e.g., comparing duration patterns using time-mediated alignment of the user's vocals with the vocal elements of the original musical track), pitch, vocal clarity, and pronunciation.

In one another embodiment, the method 100 calculates a word and sentence pronunciation score from a word-by-word pronunciation match comparing the user's lyrics as uttered/sung against a native speaker model or against the vocal elements of the original musical track. In one embodiment, scoring of a user's performance based on pronunciation may be executed in accordance with any of the methods described in commonly assigned U.S. Pat. No. 6,055,498 (issued Apr. 25, 2000 to Neumeyer et al.) and U.S. Pat. No. 6,226,611 (issued May 1, 2001 to Neumeyer et al.).

In another embodiment, the method 100 may incorporate cepstral information in step 114 in order to provide the user with an indication of a known singer whose performance the user's performance most closely resembles (e.g. “You sound like Madonna”).

In one embodiment, the score provided to the user in step 114 is a single metric representing an overall assessment of the user's performance (e.g., a cumulative or aggregated assessment of one or more of the parameters discussed above). In another embodiment, the calculated score breaks the user's performance into segments and assesses these segments individually (e.g., “In the first segment your pitch was perfect, but in the n^{th} segment your pitch deviated from the original musical track”).

In one embodiment, scoring in accordance with step 114 is provided after a user completes his or her performance. However, in an alternative embodiment, scoring in accordance with step 114 is provided in real time, e.g., as the user performs. Real-time feedback enables a user to adjust his or her performance in order to attempt to achieve a desired score or result.

The method 100 terminates in step 116.

The method 100 thus may be implemented to transform virtually any existing computing device into a karaoke system capable of adapting original musical tracks for karaoke use. Moreover, the method 100 may be implemented to “score” a user's performance based on a comparison to the original musical track. Thus, the method 100 enables an existing computing device to perform advanced karaoke functions without the need to purchase additional hardware or dedicated machinery.

Those skilled in the art will appreciate that although the present invention has been described within the exemplary context of a karaoke application, the methods of the present invention may also be implemented for use in conjunction with any application that requires the synchronized broadcast of an audio or video signal with text transcription (e.g., closed captioning).

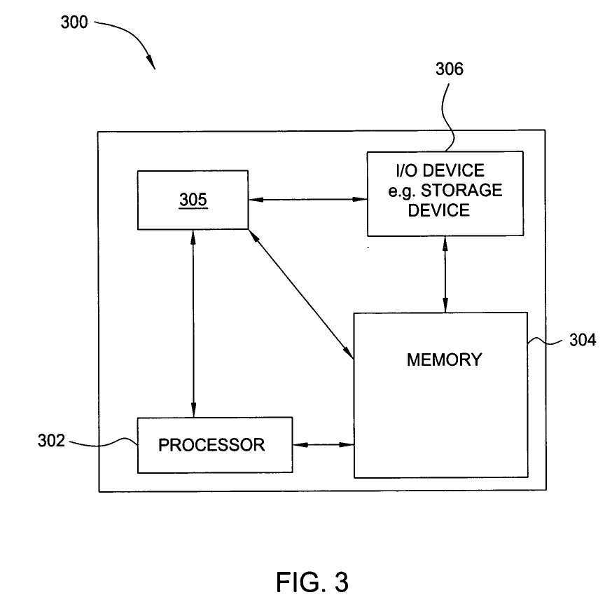

FIG. 3 is a high-level block diagram of the karaoke adaptation method that is implemented using a general purpose computing device 300. In one embodiment, a general purpose computing device 300 comprises a processor 302, a memory 304, a karaoke adaptation module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the karaoke adaptation module 305 can be implemented as a physical device or subsystem that is coupled to a processor through a communication channel.

Alternatively, the karaoke adaptation module 305 can be represented by one or more software applications (such as shareware, or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the karaoke adaptation module 305 for adapting original musical tracks described herein with reference to the preceding Figures can be stored on a computer readable medium or carrier (e.g., RAM, magnetic or optical drive or diskette, and the like).

Thus, the present invention represents a significant advancement in the field of karaoke. A method and apparatus are provided that allow a user to transform virtually any computing device into a karaoke machine. Moreover, the method and apparatus of the present invention allow a user to transform virtually any original music track into a track that is usable for karaoke purposes (e.g., comprising displayable lyrics synchronized with a playable musical track). The present invention therefore enhances the karaoke capabilities of an existing computing device without the need to purchase additional hardware or dedicated machinery.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for adapting an original musical track, the original musical track comprising a first portion comprising a plurality of vocal elements and a second portion comprising a plurality of non-vocal elements, the method comprising:
aligning said plurality of vocal elements with one or more corresponding text transcriptions of said plurality of vocal elements; and
playing said plurality of non-vocal elements and displaying an aligned text transcription of said plurality of vocal elements in a substantially synchronous manner.

2. The method of claim 1, further comprising:
separating the original musical track into said first portion and said second portion prior to said aligning.

3. The method of claim 2, wherein said aligning further comprises:
identifying non-vocal elements not separated from said first portion of said original musical track; and
adding said identified non-vocal elements to said second portion of said original musical track.

4. The method of claim 1, wherein said displaying comprises:
indicating a time at which words contained in said aligned text transcription of said plurality of vocal elements should be uttered, based at least in part on a time at which said words are uttered in said original musical track.

5. The method of claim 1, wherein said displaying comprises:
indicating a manner in which words contained in said aligned text transcription of said plurality of vocal elements should be emphasized, based at least in part on a manner in which said words are emphasized in said original musical track.

6. The method of claim 1, further comprising:
assessing a user's performance of said plurality of vocal elements.

7. The method of claim 6, wherein said assessment comprises a single metric providing an overall assessment of said user's performance.

8. The method of claim 6, wherein said assessment comprises a plurality of individual metrics relating to a plurality of individual portions of said user's performance.

9. The method of claim 6, wherein said assessment is provided following a completion of said user's performance.

10. The method of claim 6, wherein said assessment is provided in real time during said user's performance.

11. The method of claim 6, wherein said assessment comprises:
identifying a known singer whose performance said user's performance resembles, said identification being based at least in part on cepstral information.

12. The method of claim 6, wherein said assessment is based on a comparison of one or more parameters of said user's performance to corresponding parameters of said original musical track.

13. The method of claim 12, wherein said one or more parameters comprise at least one of: a timing, a duration pattern, a pitch, a vocal clarity and a pronunciation.

14. The method of claim 1, wherein said original musical track is obtained from a compact disc, a digital music file, or a video recoding.

15. The method of claim 1, wherein said one or more corresponding text transcriptions are manually input by a user.

16. The method of claim 1, wherein said one or more corresponding text transcriptions are retrieved from a local or remote file.

17. The method of claim 1, wherein said aligning comprises:
cutting one or more waveforms representing said vocal elements to span said one or more corresponding text transcriptions;
forcibly aligning said one or more waveforms with said one or more corresponding text transcriptions; and
flexibly aligning said one or more waveforms with said one or more corresponding text transcriptions using one or more flexible alignment lattices.

18. A computer readable medium containing an executable program for adapting an original musical track, the original musical track comprising a first portion comprising a plurality of vocal elements and a second portion comprising a plurality of non-vocal elements, where the program performs the steps of:
aligning said plurality of vocal elements with one or more corresponding text transcriptions of said plurality of vocal elements; and
playing said plurality of non-vocal elements and displaying an aligned text transcription of said plurality of vocal elements in a substantially synchronous manner.

19. The computer readable medium of claim 18, further comprising:
separating the original musical track into said first portion and said second portion prior to said aligning.

20. The computer readable of claim 19, wherein said aligning further comprises:
identifying non-vocal elements not separated from said first portion of said original musical track; and
adding said identified non-vocal elements to said second portion of said original musical track.

21. The computer readable of claim 18, wherein said displaying comprises:
indicating a time at which words contained in said aligned text transcription of said plurality of vocal elements should be uttered, based at least in part on a time at which said words are uttered in said original musical track.

22. The computer readable of claim 18, wherein said displaying comprises:
indicating a manner in which words contained in said aligned text transcription of said plurality of vocal elements should be emphasized, based at least in part on a manner in which said words are emphasized in said original musical track.

23. The computer readable of claim 18, further comprising:
assessing a user's performance of said plurality of vocal elements.

24. The computer readable of claim 23, wherein said assessment comprises a single metric providing an overall assessment of said user's performance.

25. The computer readable of claim 23, wherein said assessment comprises a plurality of individual metrics relating to a plurality of individual portions of said user's performance.

26. The computer readable of claim 23, wherein said assessment is provided following a completion of said user's performance.

27. The computer readable of claim 23, wherein said assessment is provided in real time during said user's performance.

28. The computer readable of claim 23, wherein said assessment comprises:
identifying a known singer whose performance said user's performance resembles, said identification being based at least in part on cepstral information.

29. The computer readable of claim 23, wherein said assessment is based on a comparison of one or more parameters of said user's performance to corresponding parameters of said original musical track.

30. The computer readable of claim 29, wherein said one or more parameters comprise at least one of: a timing, a duration pattern, a pitch, a vocal clarity and a pronunciation.

31. The computer readable of claim 18, wherein said original musical track is obtained from a compact disc, a digital music file, or a video recoding.

32. The computer readable of claim 18, wherein said one or more corresponding text transcriptions are manually input by a user.

33. The computer readable of claim 18, wherein said one or more corresponding text transcriptions are retrieved from a local or remote file.

34. The computer readable of claim 18, wherein said aligning comprises:
cutting one or more waveforms representing said vocal elements to span said one or more corresponding text transcriptions;
forcibly aligning said one or more waveforms with said one or more corresponding text transcriptions; and
flexibly aligning said one or more waveforms with said one or more corresponding text transcriptions using one or more flexible alignment lattices.

35. An apparatus for adapting an original musical track, the original musical track comprising a first portion comprising a plurality of vocal elements and a second portion comprising a plurality of non-vocal elements, the apparatus comprising:
means for aligning said plurality of vocal elements with one or more corresponding text transcriptions of said plurality of vocal elements; and
means for playing said plurality of non-vocal elements and displaying an aligned text transcription of said plurality of vocal elements in a substantially synchronous manner.

36. The apparatus of claim 35, further comprising:
means for separating the original musical track into said first portion and said second portion prior to said aligning.
